(19) United States
(12) Patent Application Publication
(10) Pub. No.: US 2018/0236913 A1
(43) Pub. Date: Aug. 23, 2018

(54) Temperature-Controlled Stroller

(71) Applicant: Manuel Abreu, Jersey City, NJ (US)

(72) Inventor: Manuel Abreu, Jersey City, NJ (US)

(21) Appl. No.: 15/900,899

(22) Filed: Feb. 21, 2018

Related U.S. Application Data
(60) Provisional application No. 62/461,253, filed on Feb. 21, 2017.

(51) Int. Cl. B60N 2/56; B62B 7/04; B62B 9/14; B62B 9/10; B60N 2/26

(52) U.S. Cl. CPC B60N 2/56; B62B 7/044; B62B 9/142; B62B 2204/04; B60N 2/26; B62B 2204/02; B62B 9/102

(57) ABSTRACT

A stroller comprising: a frame; a seat on the frame for receiving a child; and a temperature-controllable element substantially adjacent to the seat for controlling the temperature of an environment of the child.

### CROSS-REFERENCE TO RELATED APPLICATION

This application claims priority to U.S. Provisional Application No. 62/461,253, filed on Feb. 21, 2017, which is incorporated by reference in its entirety.

### FIELD

The present disclosure relates to a stroller, in particular to a temperature-controlled stroller.

### BACKGROUND

Baby strollers are known which leave the baby therein exposed to the local environment and climate. Such environmental conditions and climate may be too hot or too cold for the baby, and thus may be harmful to the baby due to the baby's still-developing immune system.

A need exists for an improved baby stroller.

### SUMMARY

A stroller comprising: a frame; a seat on the frame for receiving a child; and a temperature-controllable element substantially adjacent to the seat for controlling the temperature of an environment of the child.

### BRIEF DESCRIPTION OF DRAWINGS

The following detailed description of presently preferred embodiments of the invention will be better understood when read in conjunction with the appended drawings. For purposes of illustrating the invention, there are shown in the drawings embodiment(s) which are presently preferred. It should be understood, however, that the invention is not limited to the precise arrangements and instrumentalities shown.

In the drawings:

FIG. 1 is a front perspective view of an embodiment of a stroller of the present invention;

FIG. 2 is a rear perspective view of the stroller of FIG. 1;

FIG. 3 is front view of the stroller of FIG. 1;

FIG. 4 is a top view of the stroller of FIG. 1;

FIG. 5 is a side view of the stroller of FIG. 1;

FIG. 6 is a perspective view of the stroller of FIG. 1 showing an embodiment of heating and cooling elements;

FIG. 7 is a top view of an embodiment of a control panel of the stroller of the present invention;

FIG. 8 is a top perspective view of an embodiment of a temperature controller of the present invention;

FIG. 9 is a rear view of the temperature controller of FIG. 8;

FIG. 10 is a front view of the temperature controller of FIG. 8;

FIG. 11 is a top perspective view of internal components of the temperature controller of FIG. 8; and

FIG. 12 is a top view of the internal components of the temperature controller shown in FIG. 11.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Although this invention will be described in its exemplary forms with a certain degree of particularity, it is understood that the present disclosure has been made only by way of example and numerous changes in the details of the construction and arrangement of parts may be employed without departing from the spirit and scope of the invention.

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

The present invention is for a new and unique temperature-controlled stroller, and provides numerous advantages that are not present in existing strollers. With the present invention, the temperature of the seating area of a stroller is controlled thus providing comfort to a passenger in a stroller.

Referring to the figures, generally, the present invention provides a temperature-controlled stroller 1 that has the ability to heat and cool an area where a child is seated. Heating and cooling elements are located below a liner of a backrest of a stroller seat, which is governed by a temperature controller mounted at a base near back wheels of the stroller.

The controller includes necessary electronic components to heat or cool the elements, similar to temperature-controlled seats of an automobile. The controller has a bank of rechargeable batteries that are rechargeable through an outlet provided in the controller. The stroller also has a solar panel mounted near the top of the unit that may collect sunlight and help to recharge the batteries. The temperature is controlled manually or by an application found on a smart phone connected to the controller via Bluetooth.

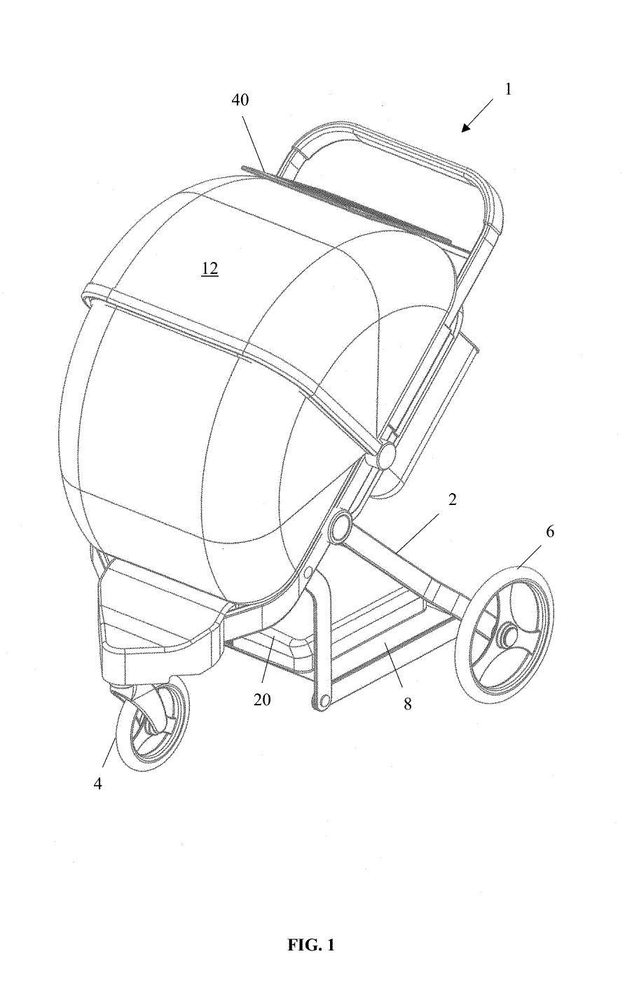

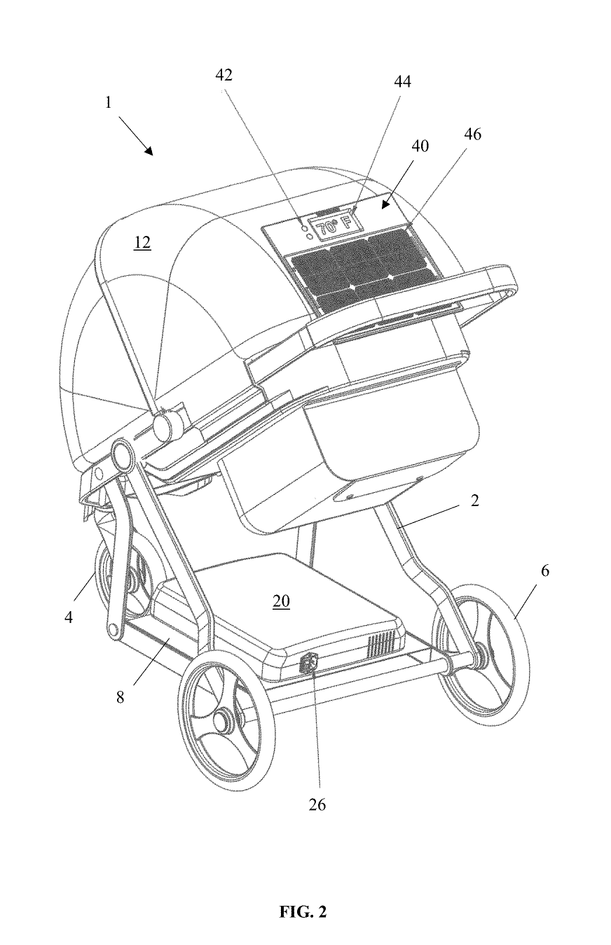

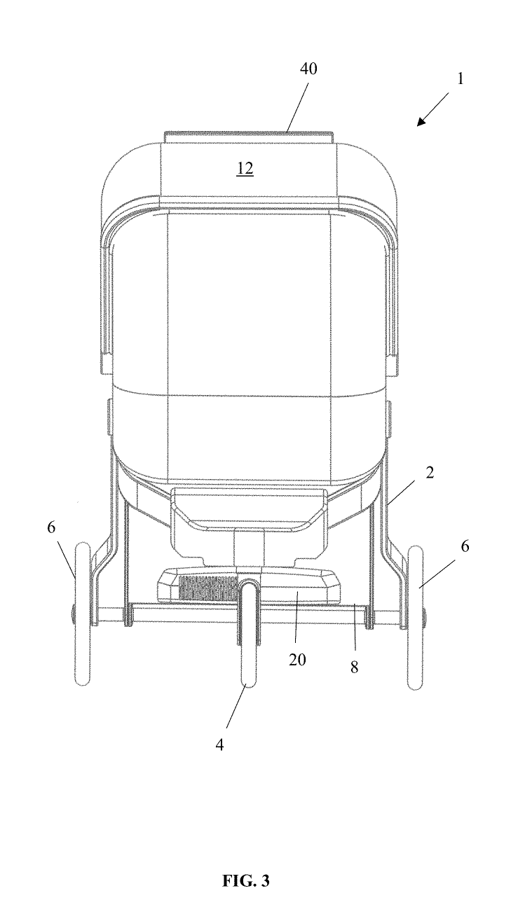

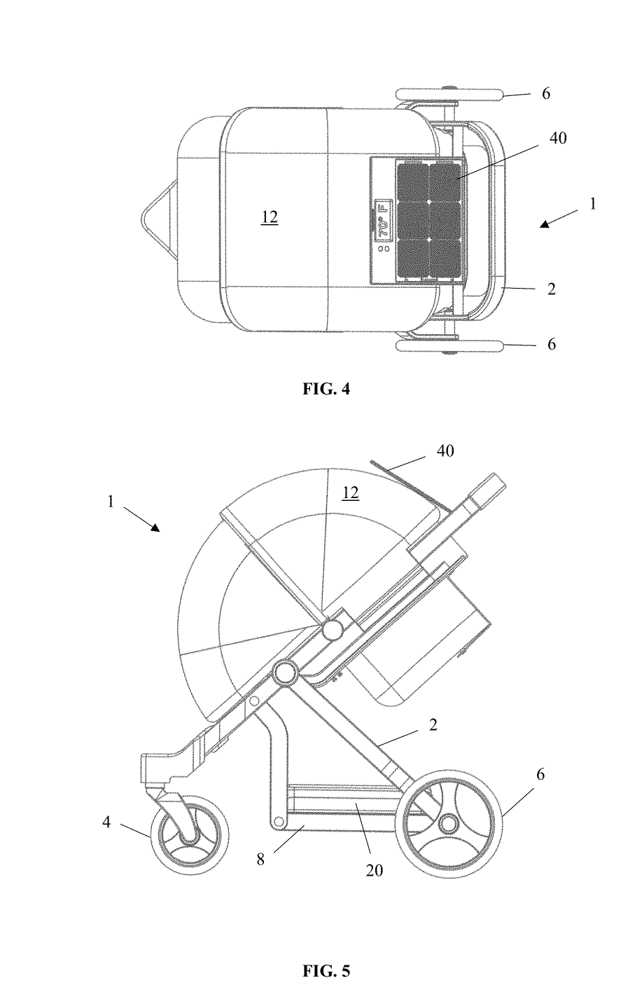

Referring to FIGS. 1-5, several views of the stroller 1 of the present invention are shown with the stroller 1 in an expanded state. The stroller 1 includes a frame 2 supported by at least one front wheel 4 and at least two rear wheels 6. A bottom portion of the frame 2 includes a base 8 positioned between the wheels 4, 6, which can be used to store items. The frame 2 is configured such that the stroller is capable of being folded to a compact folded state (not shown). The frame 2 is preferably constructed of a light-weight metal or high-strength plastic.

Referring to FIG. 6, the stroller 1 includes a seat 10, which is supported by the frame 2. The seat 10 is provided with a removable cover 12, as shown in FIGS. 1-5. The cover 12 could be completely removed a shown in FIG. 6 or foldable, and could be folded into one or more sections in one or more directions. The cover 12 is preferably constructed of a flexible, water-resistant material such as but not limited to vinyl, nylon, polyester or a combination thereof. In one embodiment, the cover 12 is opened by spring action and held closed by an electromagnet. This can enable the cover 12 to be opened electronically. In addition, as a safety measure, a loss of power disables the magnet and the cover 12 opens by spring action.

Referring again to FIG. 6, the seat 10 also includes a seat cover (not shown), and at least one heating/cooling element 14 is included on a back portion of the seat underneath the seat cover. The seat cover could be an air permeable material so that heat (hot or cold) is efficiently transferred through the seat cover while protecting the passenger from excessive temperatures from the heating/cooling element 14.

In one embodiment, the heating/cooling element 14 is a continuous hollow tube for transferring air, liquid or gas. In this embodiment, if heat is desired a hot or warm material is transferred through the tube, and if air-conditioning is desired a cold material is transferred through the tube. As such, the stroller 1 could be provided with removable and interchangeable heating/cooling elements. For example, during cold seasons, the heating/cooling elements 14 could include antifreeze liquid for heating and during warm seasons a different heating/cooling element 14 having, for example, a refrigerant like Freon, could be installed for cooling. Alternatively, the heating/cooling element 14 could be configured to include dual tubes or conduits extending side-by-side to accommodate each option.

In another embodiment, the heating/cooling element 14 includes a continuous insulated electrical coil arranged in a substantially flat and planar configuration. In this embodiment, the electrical coil is heated by electrical power to provide heat to the passenger.

In a further embodiment, the electrical coil could be insulated from but circumscribed by a hollow tube such that when heat is desired the electrical coil is heated and when air-conditioning is desired cool air or gas is circulated through the insulated hollow portion.

Alternatively, the heating/cooling element 14 could comprise multiple tubes and/or coils, instead of one continuous tube or coil, for circulating warm or cold materials and/or electrical heating elements therethrough.

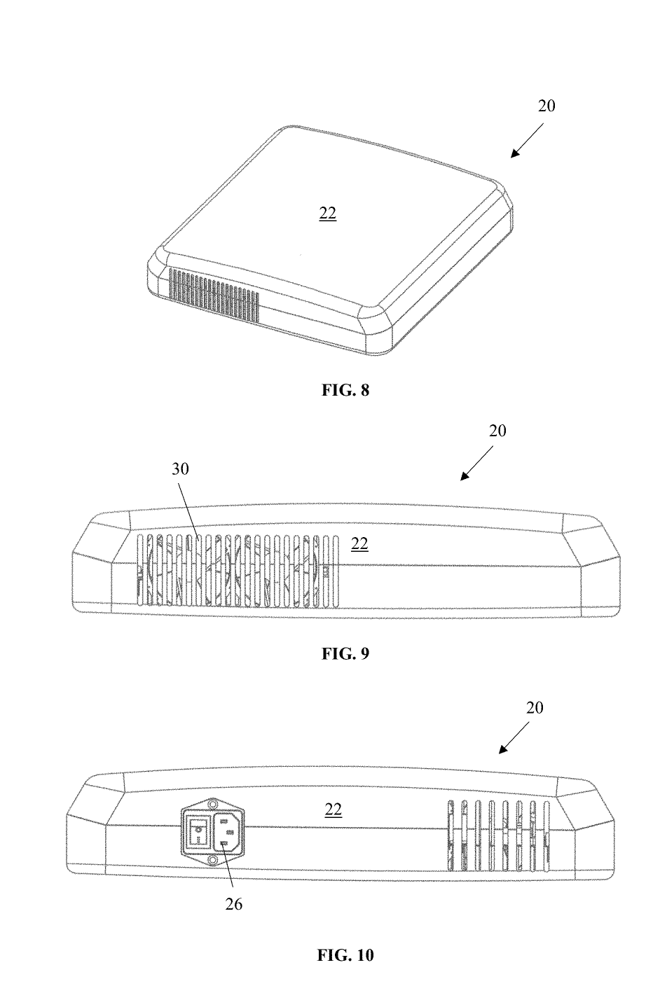

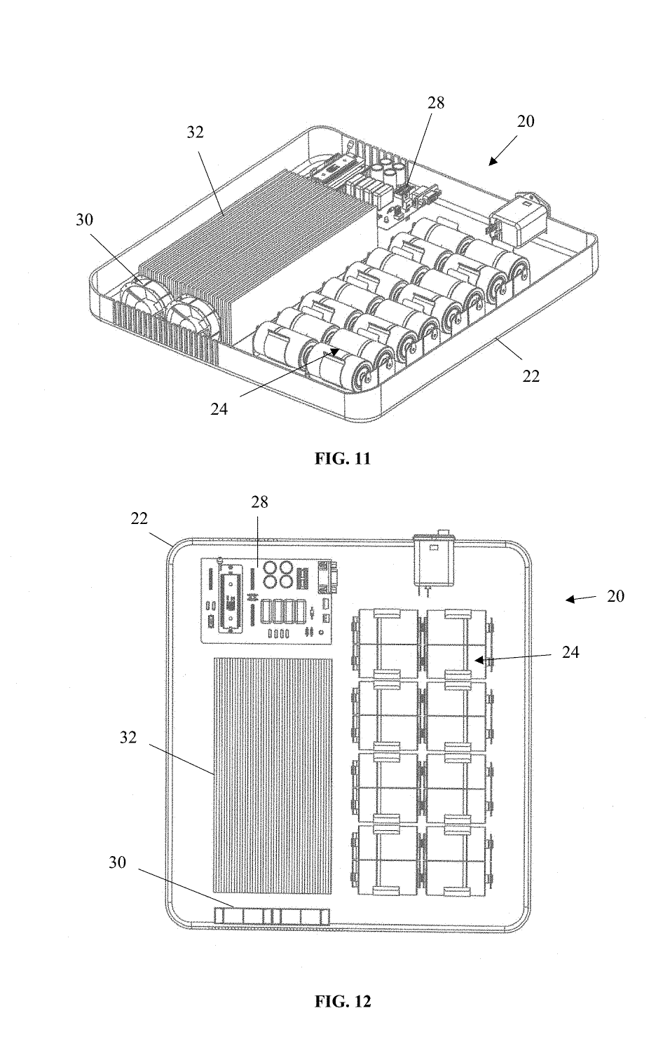

Referring to FIGS. 8-12, the heating/cooling element 14 is operably coupled to a controller 20. That is, electrical wires and/or conduits (not shown) are connected to and from the heating/cooling element 14 and the controller 20, which is positioned on the base 8 as shown in FIGS. 1-6. The electrical wires and/or conduits are attached to the frame 2 such that the connection therebetween is not impeded when the stroller is in an expanded state and a folded state (not shown).

Referring again to FIGS. 8-12, the controller 20 includes a case 22, preferably made of molded plastic, which is separable for access to an inner portion thereof. The controller 20 includes at least one rechargeable battery 24 for powering a micro-processor 28 and a fan 30 within the controller 20. Other devices (described below) could be powered by the battery 24 as well. A heat sink 32 is provided for air-conditioning, which is described in more detail below. The batteries 24 are also operably coupled to a power plug 26 for recharging.

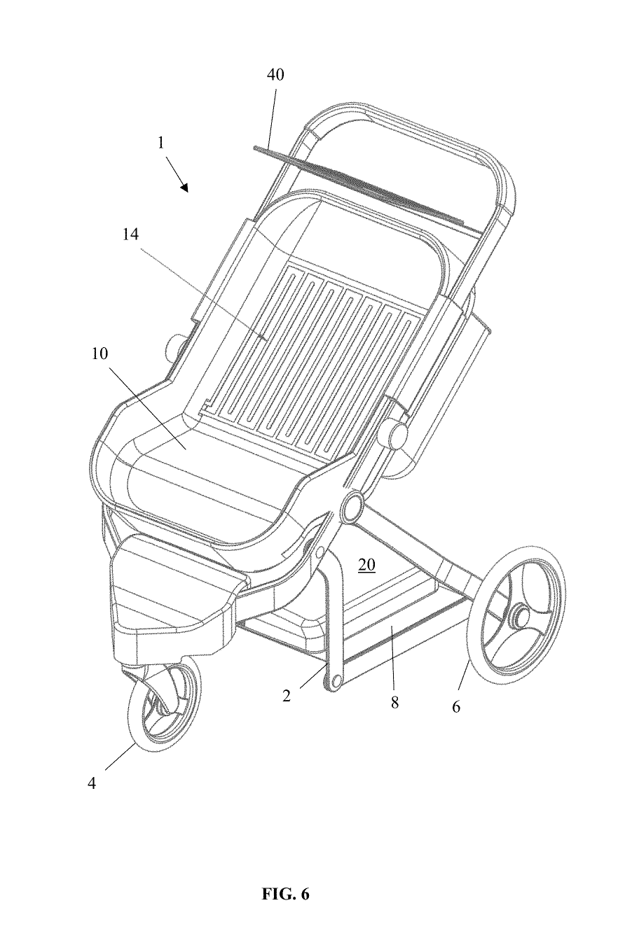

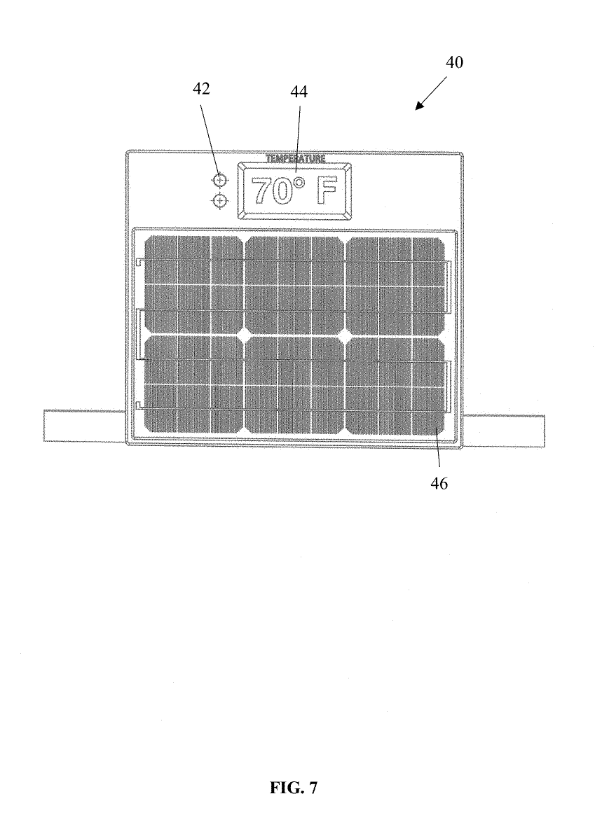

Referring to FIG. 7, the controller 20 is operably coupled to a control panel 40 which is mounted to an upper portion of the frame 2, as shown in FIGS. 1-6. In this embodiment, the control panel 40 includes on/off switches 42 as well as a temperature gauge 44. In other embodiments, the control panel 40 could include other functions such as temperature control so that the temperature of the seat 10 could be set to a desired temperature, a power indicator to advise the user of remaining power, and a speaker to audibly alert the user of temperature changes. The control panel 40 also includes a solar panel 46 which is operably coupled to the batteries 24 of the controller 20. Thus, the batteries 24 are recharged via solar energy when the solar panel 46 is exposed to light.

In another embodiment, the controller 20 and/or control panel 40 is operably coupled to an external device such as a smart phone (not shown) by known means such as Bluetooth technology such that the temperature of the seat 10 could be controlled remotely. In addition, the external device could display other information such as those described above.

In operation, cooling is accomplished in a number of different ways. If circulating a refrigerant such as Freon, a compressor (not shown) is provided at or near the controller 20. The refrigerant is compressed and circulated through the heat sink 32 via a pump (not shown) as the fan 30 dissipates the heat from the heat sink 32. The refrigerant is then decompressed by a decompressor (not shown) provided at or near the controller 20 and circulated through the heating/cooling element 14 by the pump. The refrigerant returns to the compressor and the cycle is continuously repeated until the seat 10 reaches a desired temperature.

Heating is accomplished in a number of different ways as well. If circulating a refrigerant, the process as described for cooling is reversed. The refrigerant is compressed and circulated through the heating/cooling element 14. The refrigerant is then decompressed and circulated through the heat sink 32, which may be heated by a heating element within or near the heatsink 32. The refrigerant returns to the compressor and the cycle is continuously repeated until the seat 10 reaches a desired temperature.

For electric coil heating, electricity is transferred to the electric coils from the controller 20 and the seat 10 is heated. Alternatively, a heat transfer material such as water or oil can be heated via electrical power by electric coils (not shown) at or near the controller 20 or by an electrically heated heatsink 20 and then circulated through a conduit by a pump (not shown) to the heating/cooling element 14 and returned to the controller 20 for re-heating and circulation.

In another embodiment, an additional fan could be provided beneath the heating/cooling elements 14 such that air is blown in the direction of the passenger's back to increase heat transfer.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes which come within the meaning and range of equivalency of the claims are to be embraced within their scope.

What is claimed is:

1. A stroller comprising:
a frame;
a seat on the frame for receiving a child; and
a temperature-controllable element adjacent to the seat for controlling the temperature of an environment of the child.

2. The stroller of claim 1, further comprising:
a controller for controlling the temperature-controllable element to selectively set the temperature of the environment.

3. The stroller of claim 1, further comprising:
a cover for covering the child disposed in the seat.

4. The stroller of claim 1, further comprising:
a battery for providing electrical power to the temperature-controllable element.

5. The stroller of claim 4, wherein the battery is rechargeable.

6. The stroller of claim 5, further comprising:
a solar panel for recharging the battery.

7. The stroller of claim 5, further comprising:
a power plug for receiving power from a power source for recharging the battery.

8. The stroller of claim 1, wherein the temperature-controllable element is heated to heat the child.

9. The stroller of claim 1, wherein the temperature-controllable element is cooled to cool the child.

10. The stroller of claim 1, further comprising:
a temperature gauge for indicating the temperature of the environment of the child.

11. The stroller of claim 2, wherein the controller is mounted to the frame.

12. The stroller of claim 2, wherein the controller is remote from the frame.

13. A stroller comprising:
a frame;
a plurality of wheels rotatably attached to the frame;
a handle attached to the frame for controlling movement of the stroller;
a seat on the frame for receiving a child;
a temperature-controllable element adjacent to the seat for controlling the temperature of an environment of the child; and
a controller for controlling the temperature-controllable element to selectively set the temperature of the environment.

14. The stroller of claim 13, further comprising:
a power source for providing electrical power to the temperature-controllable element.

15. The stroller of claim 13, further comprising:
a cover for covering the child disposed in the seat.

16. The stroller of claim 13, wherein the controller is mounted to the frame.

17. The stroller of claim 13, wherein the controller is remote from the frame.

18. The stroller of claim 13, wherein the temperature-controllable element is heated or cooled to heat or cool the child, respectively.

19. A method comprising:
providing a stroller having a frame, a plurality of wheels rotatably attached to the frame, a handle attached to the frame for controlling movement of the stroller, a seat on the frame for receiving a child, a temperature-controllable element adjacent to the seat for controlling the temperature of an environment of the child, a power source for providing power to the temperature-controllable element, and a controller for controlling the temperature-controllable element to selectively set the temperature of the environment;
disposing the child in the seat;
receiving a temperature selection from a user; and
heating or cooling the child to the selected temperature.

20. The method of claim 19, further comprising:
providing a rechargeable battery as the power source; and
charging the rechargeable battery.
